(19) United States
(12) Patent Application Publication
(10) Pub. No.: US 2020/0117973 A1
(43) Pub. Date: Apr. 16, 2020

(54) RFID System and Method for Creating an RFID System

(71) Applicant: Relytex GmbH & Co. KG, Landshut (DE)

(72) Inventors: Rolf Schumacher, Balingen (DE); Harald Katschke, Memmingerberg (DE)

(21) Appl. No.: 16/592,900

(22) Filed: Oct. 4, 2019

(30) Foreign Application Priority Data
Oct. 16, 2018 (EP) 18200688.2

(51) Int. Cl. G06K 19/077

(52) U.S. Cl. CPC G06K 19/07788

(57) ABSTRACT

An RFID system with an RFID chip and a transmitting and/or receiving antenna that are applied onto a substrate material for sending and/or receiving electromagnetic waves. The transmitting and/or receiving antenna is formed by only a single electrically conductive thread that forms a linear, non-intersecting structure. A segment of the electrically conductive thread loops around the RFID chip without touching it across an angle of at least 180°, by which a capacitive coupling is effected between the RFID chip and the transmitting and/or receiving antenna. The invention further relates to a method for producing an RFID system.

### CROSS REFERENCE TO RELATED APPLICATIONS

This application claims the priority of EP 18200688.2 filed on 2018 Oct. 16; this application is incorporated by reference herein in its entirety.

### BACKGROUND

The invention relates to an RFID system and a method for producing an RFID system.

Such RFID systems are used as identification systems, in particular.

The RFID system works with a read/write device such that data can be read from an RFID chip and transmitted to the read/write device via an RFID antenna.

Identification data with which an object tagged with the RFID chip can be identified is stored on the RFID chip.

Such identification systems are increasingly used in textiles as well, especially in the apparel industry and in the area of technical textiles.

In this case, the RFID chip and the transmitting and/or receiving antenna are printed, etched or stitched onto a textile support.

A first problem with such systems is that the application of transmitting and/or receiving antennae on the textile substrate is very time-consuming.

A second problem consists in designing the transmitting and/or receiving antenna such that it can be used to achieve the necessary ranges for data transmission with the read/write device.

### SUMMARY

The invention relates to an RFID system (1) with an RFID chip (2) and a transmitting and/or receiving antenna (3) that are applied onto a substrate material (4) for sending and/or receiving electromagnetic waves. The transmitting and/or receiving antenna (3) is formed by only a single electrically conductive thread (5) that forms a linear, non-intersecting structure. A segment of the electrically conductive thread (5) loops around the RFID chip (2) without touching it across an angle of at least 180°, by which a capacitive coupling is effected between the RFID chip (2) and the transmitting and/or receiving antenna (3). The invention further relates to a method for producing an RFID system (1).

### DETAILED DESCRIPTION

The invention seeks to solve the problem of providing an RFID system that can be efficiently manufactured and yet has a high degree of functionality.

To solve this problem, the features of the independent claims are provided. Advantageous embodiments and expedient further developments are described in the dependent claims.

The invention relates to an RFID system with an RFID chip and a transmitting and/or receiving antenna that are applied to a substrate in order to transmit and/or receive electromagnetic waves. The transmitting and/or receiving antenna is formed only by a single electrically conductive thread that forms a linear, non-intersecting structure. A segment of the electrically conductive thread loops around the RFID chip without touching it, across an angle of at least 180°, by which capacitive coupling is effected between the RFID chip and the transmitting and/or receiving antenna.

The invention also relates to a corresponding method.

An essential advantage of the invention consists in that the transmitting and/or receiving antenna associated with the RFID chip can be used to achieve very long ranges, which can typically be several metres, for contactless data transfer with an external unit, especially a read/write device.

By way of an advantageous geometry, the transmitting and/or receiving antenna can be used to achieve ranges in excess of 6 meters, whereby large quantities of data can be transmitted over these ranges. This is of interest especially for applications such as delivery of pieces of industrial textiles in containers.

According to the invention, these long ranges are achieved with a very simple antenna structure. The transmitting and/or receiving antenna according to the invention consists solely of a linear and non-intersecting electrically conductive thread applied to the substrate material, wherein it is essential that a segment of this electrically conductive thread be arranged around the RFID chip such that this segment loops around the RFID chip across an angle range of at least 180°, preferably across an angle range between 180° and 270°. Typically, the RFID chip has an at least approximately circular outer contour. Since only one and not several electrically conductive threads form the transmitting and/or receiving antenna and the electrically conductive thread is arranged in a linear and non-intersecting manner on the substrate material, the electrically conductive thread cannot loop around the RFID chip for the entire circumference of 360° since a closed loop cannot be formed. Rather, the electrically conductive thread forms an open loop that the electrically conductive thread only loops around across a partial range of 360°, whereby the electrically conductive thread is arranged around the RFID chip in a linear manner.

To ensure purely capacitive coupling of the transmitting and/or receiving antenna with the RFID chip, the transmitting and/or receiving antenna does not touch the RFID chip, but rather is arranged around the RFID chip at a small, preferably approximately constant distance from it.

The path of the segment looping around the RFID chip does not have to be exactly matched to the outer contour of the RFID chip, however.

In particular, the segment of the electrically conductive thread looping around the RFID chip can be arranged in the form of a polygonal chain.

With regard to production methods, such geometries can be realized especially easily.

An advantageous further development of the invention provides that the transmitting and/or receiving antenna be designed in the form of a double antenna, which has two electrically conductive threads that run at a constant distance from one another.

This further increases the transmission and/or receiving performance of the transmitting and/or receiving antenna.

This embodiment of a double antenna can be formed such that the electrically conductive threads do not run parallel for the entire region of the transmitting and/or receiving antenna. Rather, the two electrically conductive threads can form a structure with multiple intersections in the outer edge regions of the transmitting and/or receiving antenna, wherein the electrically conductive structures are electrically contacted at the intersection points. The specific arrangement of the intersecting structure can be used to selectively modify the frequency range of the transmitting and/or receiving antenna.

In principle, the electrically conductive thread can be worked into the substrate using a knitting machine, in particular, a flat knitting machine.

Furthermore, warp knitting machines are also suitable for working transmitting and/or receiving antennas into the substrate material.

To produce the transmitting and/or receiving antenna, it is especially advantageous to use a tricot machine or Raschel machine, in particular, a nonwoven Raschel machine.

With such machines, the transmitting and/or receiving antennas can be quickly and efficiently worked into the substrate material, such that an economic production process of the transmitting and/or receiving antennas is ensured.

Another advantage is that with the tricot machine or Raschel machine, transmitting and/or receiving antennas can be produced in virtually any shape and geometry, whereby especially the length of the transmitting and/or receiving antenna that encompasses the frequency range of electromagnetic waves to be transmitted or received can be flexibly prescribed.

It is especially advantageous for the tricot machine or Raschel machine to have a variable weft insertion by means of which the length of a transmitting and/or receiving antenna is prescribed.

This makes it especially simple, efficient and precise to prescribe the frequency or frequency range of the transmitting and/or receiving antennas.

According to an advantageous embodiment of the invention, the tricot machine or Raschel machine has electronic guide bars by means of which the position of a transmitting and/or receiving antenna can be freely prescribed on the textile substrate material.

In contrast to conventional guide bars, the electronic guide bars of the tricot machine or Raschel machine are not pattern-bound, such that these electronic guide bars can be used to freely prescribe the positions of the transmitting and/or receiving antennas on the substrate material without design restrictions.

The electrically conductive threads used to produce the transmitting and/or receiving antennas consist, in full or in part, of an electrically conductive material.

In this regard, metallic and non-metallic materials can generally be used.

According to an advantageous embodiment, the electrically conductive thread consists of a polymer/stainless steel hybrid yarn.

The substrate material generally forms an electrically insulating structure upon which the transmitting and/or receiving antennas are applied, i.e. the substrate material consists entirely of electrically non-conductive materials. It is advantageous for a textile substrate material to be provided.

In this regard, the textile substrate material can be a woven, knitted, nonwoven, non-crimp fabric or braided fabric.

It is expedient for the electrically conductive threads that form the transmitting and/or receiving antennas to be affixed to the textile substrate material by means of electrically insulating binding threads.

It is especially advantageous for the binding threads to be applied to the textile substrate material by means of at least one guide bar of the tricot machine or Raschel machine.

This means it is possible, using the same tricot machine or Raschel machine with which the electrically conductive threads to form the transmitting and/or receiving antenna are worked into the textile substrate material, to work in also the binding threads to affix the transmitting and/or receiving antenna, whereby the working-in of the electrically conductive threads into the substrate material and their affixing with the binding threads can take place within a single work process, which results in a high degree of efficiency.

It is advantageous in this regard for the density of binding threads to be varied depending upon the geometric structure of the transmitting and/or receiving antennas.

In this way, the transmitting and/or receiving antenna is affixed especially well to the substrate material, while simultaneously the amount of material used for binding threads is kept low.

In the regions with high curvature in the transmitting and/or receiving antennas, the density of binding threads is higher than in the regions with low curvature, since in the regions of the transmitting and/or receiving antennas with high curvature, more binding threads per unit of length are required in order to securely affix this highly curved structure.

The textile substrate materials according to the invention along with the RFID system applied there can be used for a plurality of different applications.

The RFID system can be a component of an identification system. In this case, identification data for an object identification are stored on the RFID chip. This identification data can be input and/or output using a read/write device.

Furthermore, such an RFID system can be a component of a monitoring system. For example, sensor signals from sensors installed for monitoring purposes can be stored on the RFID chip and read by the read/write device for the purpose of performing checks.

An example of such a monitoring system is a tarpaulin on which conductive sensor structures are worked in across the entire surface. In the event of manipulation, especially penetration of the conductive structures, the sensor structures generate sensor signals that can be transmitted to the read/write device by the RFID chip. Objects requiring protection can be securely packed with such tarpaulins.

### BRIEF DESCRIPTION OF THE DRAWINGS

The invention is explained below based on the drawings. They show:

FIG. 1: First exemplary embodiment of the RFID system according to the invention.

FIG. 1A: Enlarged depiction of the arrangement from FIG. 1.

FIG. 2: Second exemplary embodiment of the RFID system according to the invention.

FIG. 3: Third exemplary embodiment of the RFID system according to the invention.

FIG. 4: Variant of the embodiment from FIG. 3.

### DETAILED DESCRIPTION OF THE PREFERRED EMBODIMENTS

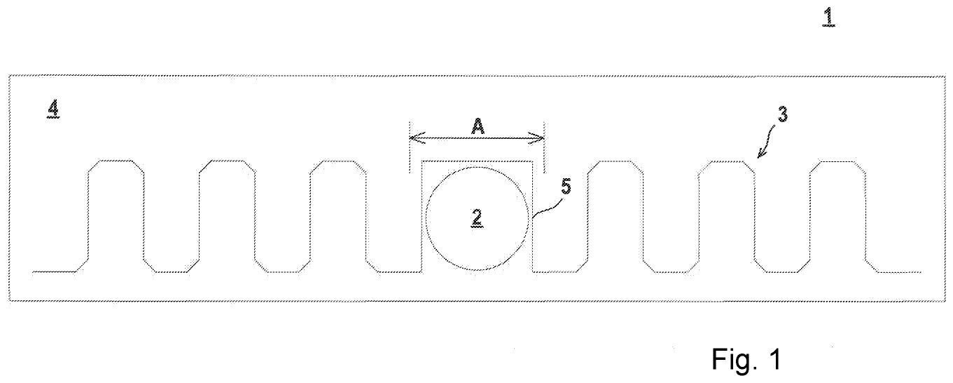

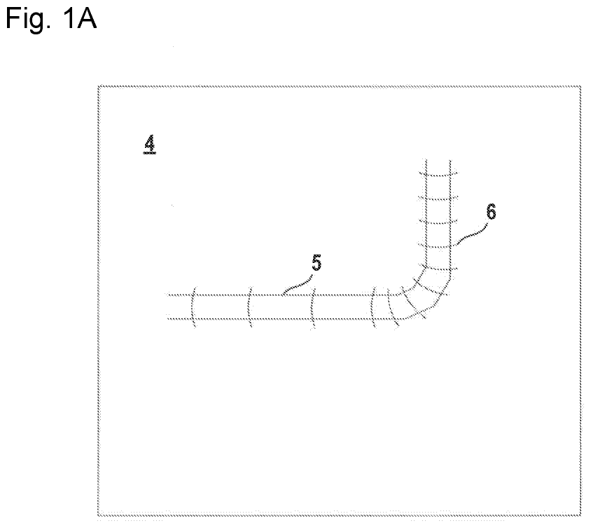

FIG. 1 shows a first exemplary embodiment of the RFID system 1 according to the invention with an RFID chip 2 and a transmitting and/or receiving antenna 3 that are printed on a textile substrate material 4.

The textile substrate material 4 consists of electrically non-conductive materials, i.e. of electrically insulating yarns or threads.

The textile substrate material 4 can be a woven, knit, nonwoven, non-crimp fabric or braided fabric.

The transmitting and/or receiving antenna 3 applied to the textile substrate material 4 generally serves to send and/or receive electromagnetic waves.

By way of the transmitting and/or receiving antenna 3, data stored on the RFID chip 2 can be output to an external unit, especially a read/write device. Furthermore, data can be input from the read/write device into the RFID chip 2 and stored on the latter.

In the present case, the RFID chip 2 is structured in the form of a flat, circular disk-shaped body that is adhered onto the textile substrate material 4.

The transmitting and/or receiving antenna 3 consists of an electrically conductive thread 5, that is made of a polymer-stainless steel hybrid yarn, in particular.

In principle, the electrically conductive thread 5 can be worked into the substrate material 4 by means of a knitting machine, especially a flat knitting machine.

It is advantageous for the electrically conductive thread 5 to be worked into the textile substrate material 4 using a warp knitting machine, especially advantageously with a tricot machine or a Raschel machine.

In the present case, a nonwoven Raschel machine is used to produce the transmitting and/or receiving antenna 3.

This nonwoven Raschel machine has a variable weft insertion with which the length of the transmitting and/or receiving antenna 3 can be selectively and precisely prescribed. With the length of the transmitting and/or receiving antenna 3, the frequency range within which the transmitting and/or receiving antenna 3 can send and/or receive electromagnetic waves is prescribed.

Furthermore, the nonwoven Raschel machine has electronic guide bars that are not bound to pattern-repeat. As such, the position of the transmitting and/or receiving antenna 3 can be freely prescribed on the textile substrate material 4.

The electrically conductive thread 5 that forms the transmitting and/or receiving antenna 3 is secured to the textile substrate material 4 by means of binding threads 6 (FIG. 1a).

The binding threads 6 consisting of electrically non-conductive materials are worked in using at least one additional guide bar of the nonwoven Raschel machine, such that the application and affixing with the binding threads 6 of the electrically conductive thread 5 forming the transmitting and/or receiving antenna 3 can be done within a single work process using the nonwoven Raschel machine.

As can be seen in FIG. 1a, the density of the binding threads 6 varies depending on the geometrical structure of the transmitting and/or receiving antenna 3.

In the regions of the transmitting and/or receiving antenna 3 with high curvature, a large number of binding threads 6 per unit of length is provided in order to securely affix onto the substrate material 4 their highly curved sections of the transmitting and/or receiving antenna 3 while preserving the shape of said sections. Conversely, in the regions of the transmitting and/or receiving antenna 3 with low curvature, a lower number of binding threads 6 is provided per unit of length.

As can be seen in FIG. 1, the electrically conductive thread 5 forms a linear, non-intersecting structure upon the substrate material 4. In Region A, a segment of the electrically conductive thread 5 forms a loop around the RFID chip 2. On both sides of this Region A, the electrically conductive thread 5 forms periodic wave-shaped structures. In the present case, these are structured in the shape of polygonal chains that can be realized especially easily using a guide bar of the nonwoven Raschel machine.

Using a guide bar of the nonwoven Raschel machine, it is equally simple to realize the surrounding loop region of the RFID chip 2, wherein in the present case the segment of the electrically conductive thread 5 follows a rectangular contour in the region of the RFID chip 2. In this regard, the segment of the electrically conductive thread 5 loops around the RFID chip 2 within an angle region that is greater than or equal to 180° but less than 360°, especially less than 270°. It is crucial that there be no direct contact between the electrically conductive thread 5 and RFID chip 2, which prevents short circuiting. This gap effects a purely capacitive coupling of the transmitting and/or receiving antenna 3 to the RFID chip 2.

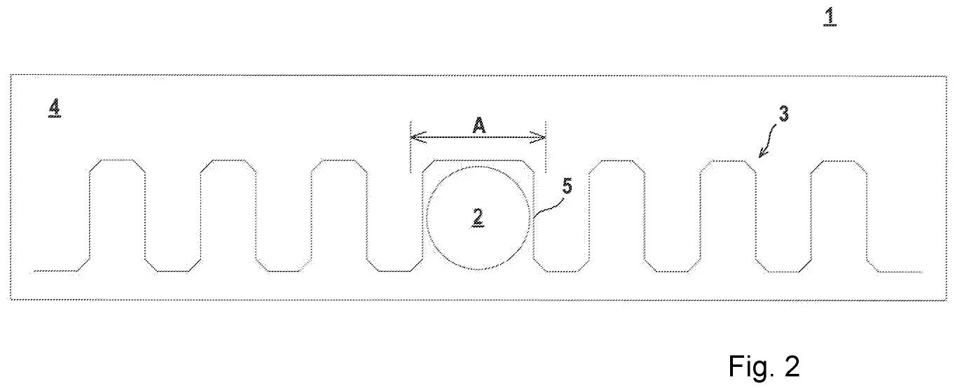

FIG. 2 shows a variant of the embodiment from FIG. 1. The modified embodiment of FIG. 2 differs from the embodiment from FIG. 1 only in that the electrically conductive thread 5 forms a polygonal chain in Region A of the loop.

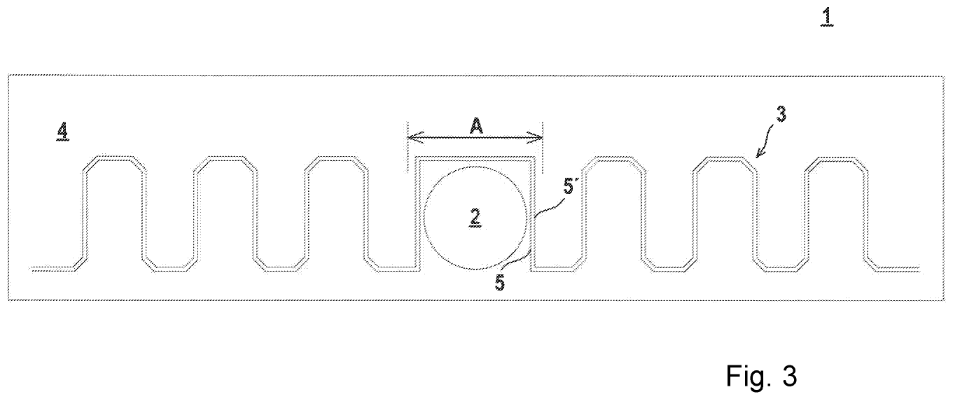

FIG. 3 shows an additional variant of the embodiment from FIG. 1. The embodiment from FIG. 3 differs from the embodiment from FIG. 1 only in that the transmitting and/or receiving antenna 3 is not formed from just one, but rather from two electrically conductive threads 5, 5′.

The two electrically conductive threads 5, 5′ run approximately parallel at a distance from one another. Accordingly, the electrically conductive threads 5, 5′ have mutually corresponding contours, wherein the electrically conductive threads 5, 5′ are electrically insulated from one another by the textile substrate material 4.

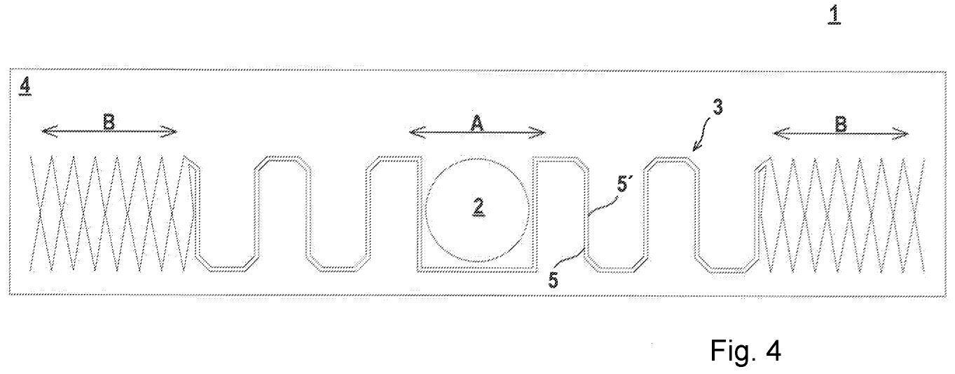

FIG. 4 shows a variant of the embodiment from FIG. 3. The embodiment from FIG. 4 differs from the example in FIG. 3 only in that the two electrically conductive threads 5, 5′ do not run parallel for the entire region of the transmitting and/or receiving antenna 3. Rather, in the outer regions B, the electrically conductive threads 5, 5′ form a structure with multiple intersections, wherein the electrically conductive threads 5, 5′ are electrically contacted at the intersection points. With these planar, intersecting structures of the electrically conductive thread 5, 5′, the frequency range of the transmitting and/or receiving antenna 3 can be selectively modified relative to the embodiment from FIG. 3.

In the present case, the regions B with the intersecting electrically conductive threads 5, 5′ have mirror symmetry. In any case, the regions B lie outside of Region A with the RFID chip.

### LIST OF REFERENCE NUMERALS

(1) RFID system
(2) RFID chip
(3) transmitting and/or receiving antenna
(4) substrate material
(5) electrically conductive thread
(5′) electrically conductive thread
(6) binding thread
A region
B outer region

1. A RFID system (1) with an RFID chip (2) and a transmitting and/or receiving antenna (3) for sending and/or receiving electromagnetic waves, applied to a substrate material (4), characterized in that the transmitting and/or receiving antenna (3) is formed by only a single electrically conductive thread (5) that forms a linear, non-intersecting structure, wherein a segment of the electrically conductive thread (5) loops around the RFID chip (2) without touching it across an angle of at least 180°, which effects a capacitive coupling between the RFID chip (2) and the transmitting and/or receiving antenna (3).

2. The RFID system (1) according to claim 1, characterized in that the electrically conductive thread (5) is worked into the substrate material (4) by means of a warp knitting machine, especially a tricot machine or Raschel machine.

3. The RFID system (1) according to claim 2, characterized in that the electrically conductive thread (5) is worked into the substrate material (4) by means of a nonwoven Raschel machine.

4. The RFID system (1) according to claim 2, characterized in that the tricot machine or Raschel machine has a variable weft insertion by means of which the length of a transmitting and/or receiving antenna (3) can be prescribed.

5. The RFID system (1) according to claim 2, characterized in that the tricot machine or Raschel machine has electronic guide bars by means of which the position of a transmitting and/or receiving antenna (3) on the substrate material (4) can be freely prescribed.

6. The RFID system (1) according to claim 1, characterized in that the electrically conductive thread (5) forming the transmitting and/or receiving antenna (3) is affixed to the substrate material (4) by means of electrically insulating binding threads (6).

7. The RFID system (1) according to claim 6, characterized in that the binding threads (6) are applied onto the substrate material (4) by means of at least one guide bar of the tricot machine or Raschel machine, whereby the density of the binding threads (6) can be varied depending on the geometric structure of the transmitting and/or receiving antenna (3).

8. The RFID system (1) according to claim 1, characterized in that the electrically conductive thread (5) is worked into the substrate material (4) by means of a knitting machine, especially a flat knitting machine.

9. The RFID system (1) according to claim 1, characterized in that an electrically insulating, especially textile, substrate material (4) is provided for.

10. The RFID system (1) according to claim 1, characterized in that the electrically conductive thread (5) consists of a polymer/stainless steel hybrid yarn.

11. The RFID system (1) according to claim 1, characterized in that the segment of the electrically conductive thread (5) loops around the RFID chip (2) within an angular range of 180° to 270°.

12. The RFID system (1) according to claim 11, characterized in that the segment of the electrically conductive thread (5) looping around the RFID chip (2) is structured in the shape of a polygonal chain.

13. The RFID system (1) according to claim 1, characterized in that the transmitting and/or receiving antenna (3) is structured in the shape of a double antenna that has two electrically conductive threads (5, 5′) that run at a constant distance from one another.

14. The RFID system (1) according to claim 13, characterized in that the double antenna, in its outer edge regions, has a multiply intersecting structure formed by the two conductive threads (5, 5′).

15. A method for producing an RFID systems (1) with an RFID chip (2) and a transmitting and/or receiving antenna (3) for sending and/or receiving electromagnetic waves, wherein the RFID chip (2) and the transmitting and/or receiving antenna (3) is applied onto a substrate material (4), characterized in that the transmitting and/or receiving antenna (3) is formed by only a single electrically conductive thread (5) that forms a linear, non-intersecting structure, wherein a segment of the electrically conductive thread (5) loops around the RFID chip (2) without touching it across an angle of at least 180°, by which a capacitive coupling is effected between the RFID chip (2) and the transmitting and/or receiving antenna (3).
